(19) United States
(12) Patent Application Publication
(10) Pub. No.: US 2026/0103130 A1
(43) Pub. Date: Apr. 16, 2026

(54) VEHICLE SEAT

(71) Applicant: TS TECH CO., LTD., Asaka-shi, Saitama (JP)

(72) Inventors: Tomoyuki KURIMOTO, Tochigi (JP); Akira MIYOSHI, Tochigi (JP)

(21) Appl. No.: 19/113,176

(22) PCT Filed: Oct. 24, 2023
(86) PCT No.: PCT/JP2023/038384

§ 371 Date: Mar. 19, 2025

Related U.S. Application Data
(60) Provisional application No. 63/419,061, filed on Oct. 25, 2022.

(30) Foreign Application Priority Data
Oct. 23, 2023 (JP) 2023-181974

(51) Int. Cl. B60N 2/70; B60N 2/30; B60N 2/38; B60N 3/02

(52) U.S. Cl. CPC B60N 2/70; B60N 2/3038; B60N 2/38; B60N 3/02

(57) ABSTRACT

There is provided a conveyance seat with improved safety. A conveyance seat includes a seat cushion; and a side support portion that is provided on a side portion of the seat cushion, and that supports thighs of an occupant, who is seated in the conveyance seat, from an outside in a seat width direction. Since the conveyance seat includes the side support portion that supports the thighs of the occupant, the occupant can support his or her lower body. Accordingly, it is possible to provide the conveyance seat that enhances physical stability when a vehicle travels on rough terrain, and that improves safety.

### CROSS-REFERENCE TO RELATED APPLICATIONS

This application is the U.S. National Stage entry of International Application No. PCT/JP2023/038384, filed on Oct. 24, 2023, which, in turn, claims priority to U.S. Provisional Ser. No. 63/419,061, filed on Oct. 25, 2022, and Japanese Patent Application No. 2023-181974, filed on Oct. 23, 2023, all of which are hereby incorporated herein by reference in their entireties for all purposes.

### TECHNICAL FIELD

The present invention relates to a conveyance seat, particularly to a conveyance seat that is installed in an off-road vehicle or the like that travels on rough terrain.

### BACKGROUND ART

When a four-wheeled off-road vehicle or the like travels on rough terrain, there is a possibility that the four-wheeled off-road vehicle shakes violently depending on the situation. When the vehicle shakes violently, there is a possibility that occupants, particularly occupants other than a driver unintentionally grasp a roll bar or a roll cage provided in the vehicle with their hands. Therefore, conventionally, grips are provided at locations other than the roll bar such that the occupants do not directly grip the roll bar or the like. PATENT LITERATURES 1 and 2 disclose a vehicle seat in which grips are provided on a seat cushion.

### CITATION LIST

### Patent Literature

PATENT LITERATURE 1: JP S60-148138 U

PATENT LITERATURE 2: JP H6-84942 U

### SUMMARY OF INVENTION

### Technical Problem

However, when a vehicle shakes violently, it is difficult to support the body of an occupant, particularly the legs of the occupant only with grips or a seat belt provided in a conveyance seat, and there has been a demand for a method and means for further improving safety.

The present invention has been made in view of the above-described problems, and an object of the present invention is to provide a conveyance seat with improved safety.

### Solution to Problem

The above-described problems are solved by a conveyance seat of the present invention, the conveyance seat including: a seat cushion; and a side support portion that is provided on a side portion of the seat cushion, and that supports thighs of an occupant, who is seated in the conveyance seat, from an outside in a seat width direction.

Since the conveyance seat includes the side support portion that supports the thighs of the occupant from the outside in the seat width direction, the lower body of the occupant can be supported. Therefore, it is possible to provide the conveyance seat that enhances physical stability when a vehicle travels on rough terrain, and that improves safety.

In addition, in the above-described configuration, it is preferable that the side support portion includes a recess recessed from an inside toward the outside in the seat width direction.

Since the side support portion includes the recess, the thighs of the occupant can be more reliably supported.

In addition, in the above-described configuration, it is preferable that the side support portion includes an inclined portion in which an upper end portion is located inside a lower end portion in the seat width direction.

Since the side support portion includes the inclined portion, the thighs of the occupant can be more reliably supported.

In addition, in the above-described configuration, it is preferable that the conveyance seat further includes a grip portion located at a front of a side portion of the conveyance seat.

Since the conveyance seat includes the grip portion at the front of the side portion, the occupant can instantaneously grasp the grip portion with the hand. In addition, since the grip portion is located at the front of the side portion of the seat cushion, for example, a passage for a seat belt can be ensured behind the seat cushion.

In addition, in the above-described configuration, it is preferable that the grip portion is supported by the side support portion.

Since the grip portion is supported by the side support portion, for example, when the occupant grips the grip portion, the occupant can more firmly support the thighs using the side support portion.

In addition, in the above-described configuration, it is preferable that an extending direction of the grip portion is inclined downward from a front toward a rear.

Since the extending direction of the grip portion is inclined downward from the front toward the rear, for example, when the vehicle shakes violently, the occupant can grip the grip portion at a natural angle, and the body of the occupant can be stably supported.

In addition, in the above-described configuration, it is preferable that the grip portion is provided on each of the right and left side portions of the seat cushion.

Since the grip portion is provided on each of the right and left side portions of the seat cushion, the occupant can grasp the grip portions with both the right and left arms, and the body of the occupant can be stably supported.

In addition, in the above-described configuration, it is preferable that the conveyance seat further includes a slide device that is provided below the seat cushion and that slidably attaches the conveyance seat to a floor surface. It is preferable that the slide device includes a lower rail fixed to the floor surface, and an upper rail that slides on the lower rail, and it is preferable that the side support portion is fixed to the upper rail.

Since the side support portion is fixed to the upper rail, the rigidity of the side support portion is improved.

In addition, in the above-described configuration, it is preferable that the grip portion is attached such that a position or an inclination angle of the grip portion in an extending direction is changeable.

Since the grip portion is attached such that the position or the inclination angle of the grip portion in the extending direction is changeable, the grip portion can be disposed at a position where is easy for the occupant to grip the grip portion.

In addition, in the above-described configuration, it is preferable that the conveyance seat further includes a grip position change unit that changes the position or the inclination angle of the grip portion in the extending direction; a seat belt including a buckle; a lock sensor that detects a locking of the buckle; and a control unit that is connected to the lock sensor, and that controls the grip position change unit. It is preferable that when the lock sensor detects the locking of the buckle, the control unit drives the grip position change unit to change the position or the inclination angle of the grip portion.

When the lock sensor detects the locking of the buckle, by changing the position or the inclination angle of the grip portion, the grip portion can be disposed at an appropriate position when the occupant is seated and locks the seat belt.

In addition, in the above-described configuration, it is preferable that the conveyance seat further includes a seat adjustment operation unit that receives an input for changing a position or a shape of the conveyance seat, and it is preferable that the seat adjustment operation unit is disposed to avoid the vicinity of the grip portion.

By disposing the seat adjustment operation unit so as to avoid the vicinity of the grip portion, when the occupant instantaneously stretches out the hand to the grip portion, a situation in which the hand touches the seat adjustment operation unit, thereby resulting in an erroneous operation, is suppressed.

In addition, in the above-described configuration, it is preferable that the conveyance seat further includes a slide device that is provided below the seat cushion and that slidably attaches the conveyance seat to a floor surface. It is preferable that the seat adjustment operation unit is a seat front-to-rear position adjustment operation unit that receives an input for adjusting a front-to-rear position of the conveyance seat using the slide device. It is preferable that the seat front-to-rear position adjustment operation unit is disposed below a front end portion of the seat cushion.

Since the seat front-to-rear position adjustment operation unit is disposed below the front end portion of the seat cushion, a situation in which the occupant accidentally touches the seat front-to-rear position adjustment operation unit, thereby resulting in an erroneous operation, is suppressed.

In addition, in the above-described configuration, it is preferable that the conveyance seat further includes a seat back; a headrest; a reclining device that rotates the seat back in a front to rear direction with respect to the seat cushion; and a seat back angle adjustment operation unit that receives an input for adjusting an inclination angle of the seat back with respect to the seat cushion using the reclining device. It is preferable that the seat back angle adjustment operation unit is disposed at an upper end portion of the seat back or a side portion of the headrest.

Since the seat back angle adjustment operation unit is disposed at the upper end portion of the seat back or the side portion of the headrest, a situation in which the occupant accidentally touches the seat back angle adjustment operation unit, thereby resulting in an erroneous operation, is suppressed.

### Advantageous Effects of Invention

According to the present invention, since the conveyance seat includes the side support portion that supports the thighs of the occupant from the outside in the seat width direction, the lower body of the occupant can be supported. Therefore, it is possible to provide the conveyance seat that enhances physical stability when the vehicle travels on rough terrain, and that improves safety.

In addition, since the side support portion includes the recess, the thighs of the occupant can be more reliably supported.

In addition, since the side support portion includes the inclined portion, the thighs of the occupant can be more reliably supported.

In addition, since the conveyance seat includes the grip portion at the front of the side portion, the occupant can instantaneously grasp the grip portion with the hand. In addition, since the grip portion is located at the front of the side portion of the seat cushion, for example, a passage for the seat belt can be ensured behind the seat cushion.

In addition, since the grip portion is supported by the side support portion, for example, when the occupant grips the grip portion, the occupant can more firmly support the thighs using the side support portion.

In addition, since the extending direction of the grip portion is inclined downward from the front toward the rear, for example, when the vehicle shakes violently, the occupant can grip the grip portion at a natural angle, and the body of the occupant can be stably supported.

In addition, since the grip portion is provided on each of the right and left side portions of the seat cushion, the occupant can grasp the grip portions with both the right and left arms, and the body of the occupant can be more stably supported.

In addition, since the side support portion is fixed to the upper rail, the rigidity of the side support portion is improved.

In addition, when the lock sensor detects the locking of the buckle, by changing the position or the inclination angle of the grip portion, the grip portion can be disposed at an appropriate position when the occupant is seated and locks the seat belt.

In addition, by disposing the seat adjustment operation unit so as to avoid the vicinity of the grip portion, when the occupant instantaneously stretches out the hand to the grip portion, a situation in which the hand touches the seat adjustment operation unit, thereby resulting in an erroneous operation, is suppressed.

In addition, since the seat front-to-rear position adjustment operation unit is disposed below the front end portion of the seat cushion, a situation in which the occupant accidentally touches the seat front-to-rear position adjustment operation unit, thereby resulting in an erroneous operation, is suppressed.

In addition, since the seat back angle adjustment operation unit is disposed at the upper end portion of the seat back or the side portion of the headrest, a situation in which the occupant accidentally touches the seat back angle adjustment operation unit, thereby resulting in an erroneous operation, is suppressed.

### BRIEF DESCRIPTION OF DRAWINGS

FIG. 1 is a perspective view of conveyance seat according to the present embodiment.

FIG. 2 is a front view of the conveyance seat when viewed from the front.

FIG. 3 is a side view of the conveyance seat when viewed from the side.

FIG. 4 is a perspective view when seen in the direction of an arrow X in FIG. 1, and is a view showing a part of a headrest and a seat back.

FIG. 5 is a view showing a modification example of the conveyance seat, and is a front view of the conveyance seat when viewed from the front.

FIG. 6 is a front view schematically showing a vehicle including a conveyance seat and a roll bar.

### DESCRIPTION OF EMBODIMENTS

### First Embodiment

Hereinafter, a configuration of a waterproof skin material and a conveyance seat according to an embodiment of the present invention will be described with reference to the drawings. However, the embodiment to be described below is one example for easy understanding of the present invention, and does not limit the present invention. Namely, the present invention can be modified or improved without departing from the concept of the present invention, and it goes without saying that the present invention includes equivalents thereof.

Incidentally, hereinafter, a conveyance seat installed in a four-wheeled off-road vehicle that is mainly used outdoors will be provided as one example of the conveyance seat, and a configuration example of the conveyance seat will be described. However, the present invention is not limited to conveyance seats used in four-wheeled off-road vehicles, and may be applied to vehicle seats installed in ground-traveling conveyances including wheels, such as an automobile and a railroad vehicle, or to seats installed in aircrafts, ships, or the like that move in environments other than the ground.

In addition, in the following description, the “front to rear direction” is a front to rear direction of the conveyance seat, and is a direction coinciding with a traveling direction when a vehicle in which the conveyance seat is installed travels. In addition, the “seat width direction” is a width direction of the conveyance seat, and is a direction coinciding with a right to left direction when viewed from an occupant seated in the seat. In addition, the “up to down direction” is an up to down direction of the conveyance seat, and is a direction coinciding with vertical direction when the vehicle travels on a horizontal surface.

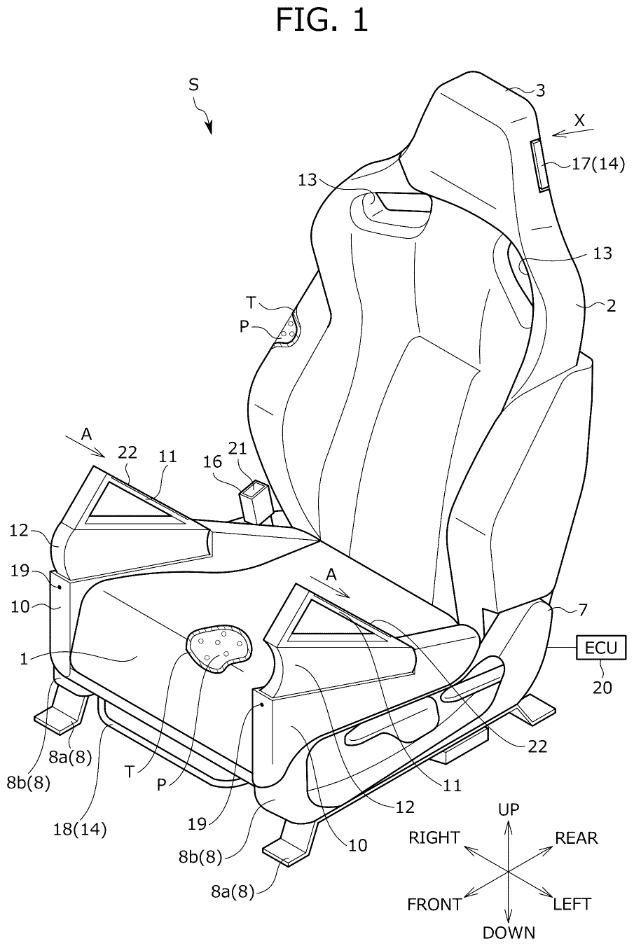

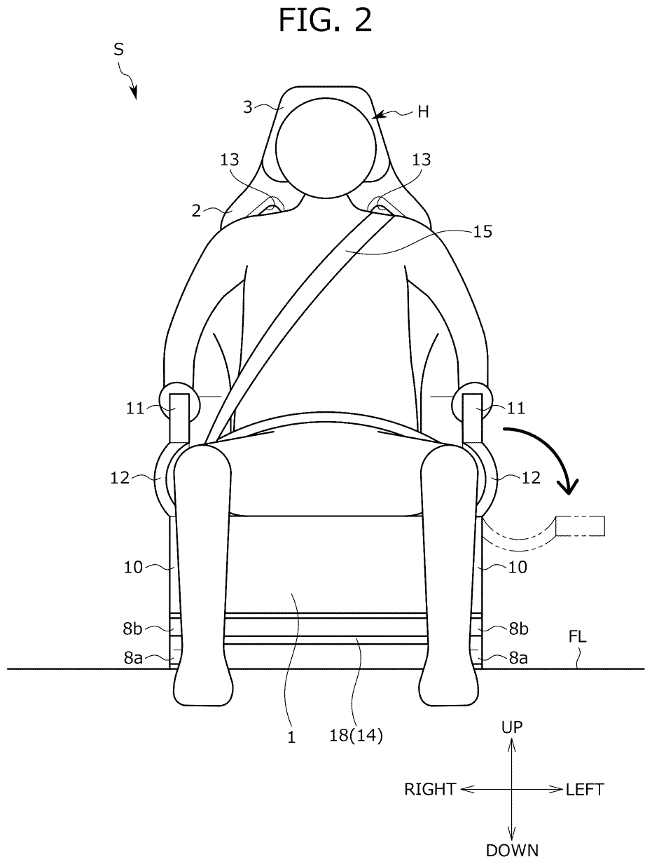

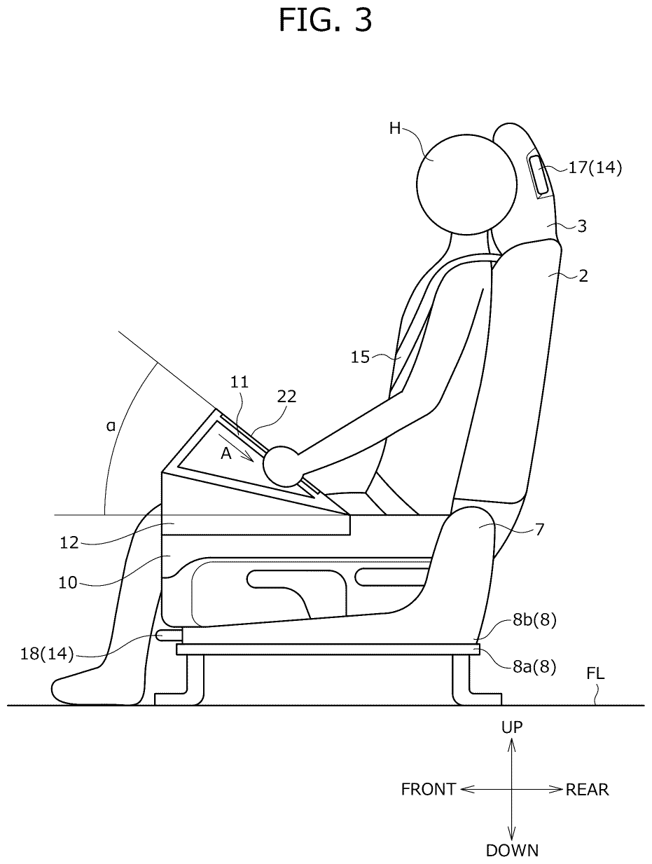

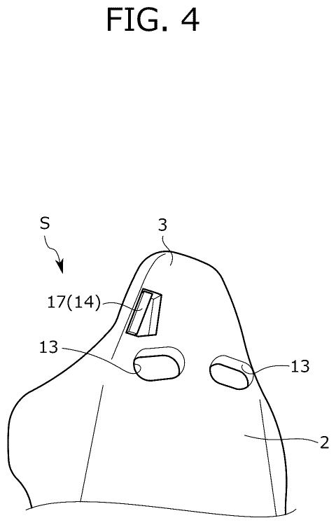

A configuration of the conveyance seat according to the present embodiment (hereinafter, a conveyance seat S) will be described with reference to FIGS. 1 to 4. FIG. 1 is a perspective view of the conveyance seat S that is installed in a four-wheeled off-road vehicle, and FIG. 2 is a front view of the conveyance seat S when viewed from the front. FIG. 3 is a view of the conveyance seat S when viewed from the side, and FIG. 4 is a perspective view when viewed in the direction of an arrow X in FIG. 1, and is a view showing a part of a headrest 3 and a seat back 2.

The conveyance seat S is a seat which is placed on a vehicle body floor (floor surface FL), and in which an occupant H (seated occupant) of the vehicle is seated. In the present embodiment, the conveyance seat S is used as a front seat corresponding to a front seat of the vehicle. However, the conveyance seat S is not limited thereto, and can also be used as a rear seat, and can also be used as a middle seat in a second row or a rear seat in a third row in a vehicle including three rows of seats in the front to rear direction.

The conveyance seat S is composed of a seat cushion 1 that supports the buttocks of the seated occupant H; the seat back 2 serving as a backrest that supports the back of the occupant H; and the headrest 3 that supports the head of the occupant H. A rear end portion of the seat cushion 1 and a lower end portion of the seat back 2 are connected to each other, and a reclining device 7 that inclines the seat back 2 is provided at the connecting portion. In addition, a slide device 8 that slides the conveyance seat S in the front to rear direction is provided below the seat cushion 1. The slide device 8 is composed of lower rails 8a attached to the floor surface FL of a vehicle V, and upper rails 8b that supports the seat cushion 1 and that slides on the lower rails 8a.

The seat cushion 1 is composed of a cushion frame (not shown) serving as a skeleton; a pad P serving as a cushion material placed on the cushion frame; and a skin T that covers the pad P.

The seat back 2 is composed of a back frame (not shown) serving as a skeleton; the pad P serving as a cushion material that covers the back frame; and the skin T that covers the pad P.

The headrest 3 is provided at an upper portion of the seat back 2. In the present embodiment, the headrest 3 is formed integrally with the seat back 2; however, the headrest 3 and the seat back 2 may be formed separately. In addition, a belt passage hole 13 through which a seat belt 15 passes is formed in the upper portion of the seat back 2.

### Grip Portion 11

In the present embodiment, as shown in FIGS. 1 and 3, the grip portion 11 that is gripped by the occupant H is provided at a position where the occupant H of the conveyance seat S naturally stretches out the hand. Specifically, the grip portion 11 is provided at the front of a side portion of the conveyance seat S. In more detail, the grip portion 11 is provided to be supported by a grip base 10 provided on a side portion of the seat cushion 1 and to be located on the front side of the seat cushion 1. Incidentally, it is preferable that the grip portion 11 is located at the front of the side portion of the conveyance seat S, and for example, the grip portion 11 may be provided by being supported by an armrest (not shown) extending from a side portion of the seat back 2.

In addition, the grip portion 11 is provided such that an extending direction of the grip portion 11 (the direction of an arrow A in FIG. 3) is inclined at a predetermined angle a with respect to the floor surface FL of the vehicle V. In other words, the extending direction of the grip portion 11 is provided to be inclined downward as the grip portion 11 extends from the front toward the rear of the conveyance seat S. In addition, the grip portion 11 is provided on each of the right and left side portions of the seat cushion 1.

When the occupant H is seated, since the front of the side portion of the conveyance seat S, more specifically, the front of the side portion of the seat cushion 1 is located at a position where the occupant I naturally stretches out the hand (refer to FIG. 3), and the grip portion 11 is provided at the position, the occupant H can naturally stretch out the hand and grasp the grip portion 11. Therefore, for example, even if the vehicle V shakes violently when traveling on rough terrain, the occupant H can grasp the grip portion 11 with an instantaneous decision. The direct grasping of a roll bar or a roll cage with the hand is suppressed, so that safety is enhanced.

In addition, since the grip portion 11 is located at the front of the side portion of the seat cushion 1, a passage through which the seat belt 15 passes can be ensured behind the seat cushion 1, and the grip portion 11 does not interfere with fastening the occupant H with the seat belt 15.

In addition, since the grip portion 11 is inclined at the predetermined angle a, it becomes easier to grip or instantaneously grasp the grip portion 11 compared to when the grip portion 11 extends in a horizontal direction, namely, parallel to the floor surface FL. In addition, since the grip portion 11 is inclined, it becomes easier for the occupant to support his or her body, for example, when the vehicle V shakes violently. It is desirable that the inclination angle a of the grip portion 11 is set to 10 degrees to 60 degrees.

In addition, since the grip portion 11 is disposed on each of the right and left side portions of the seat cushion 1, the occupant H can support his or her body with both arms, so that physical stability when the vehicle V travels on a rough road is enhanced.

The grip portion 11 may be provided with a lighting device 22. By illuminating the lighting device 22 when the vehicle V travels at night, the position of the grip portion 11 becomes clear, so that the occupant H can reliably grasp the grip portion 11.

### Grip Base 10

The grip bases 10 that support the grip portions 11 are provided on the side portions of the seat cushion 1. The grip bases 10 correspond to side support portions of the present invention, and support the thighs of the occupant H from the outside in the seat width direction.

Recesses 12 recessed from the inside of the seat toward the outside are formed in the grip bases 10. The recesses 12 form groove portions extending in the seat front to rear direction, and the recesses 12 are formed to extend along the thighs of the seated occupant H. As shown in FIG. 2, the cross section of the recesses 12 is formed in an arch shape or sector shape to conform to the outer shape of the thighs. Since the recesses 12 are formed in the grip bases 10 in such a manner, the occupant H can stabilize his or her lower body by opening the legs, particularly the thighs toward the outside of the seat and pressing the thighs against the recesses 12 when the vehicle V travels on a rough road.

Lower ends of the grip bases 10 are directly fixed to the upper rails 8b of the slide device 8. The rigidity of the grip bases 10 is improved by fixing the grip bases 10 to the upper rails 8b, so that even when the thighs are pressed against the grip bases 10, the grip bases 10 can stably support the lower body of the occupant H.

### Seat Adjustment Operation Unit 4

The conveyance seat S of the present embodiment is provided with the reclining device 7 and the slide device 8, and a seat adjustment operation unit 14 that enables the occupant H to operate each of the devices is attached to the conveyance seat S. Specifically, as the seat adjustment operation units 14, a reclining operation lever 17 for operating the reclining device 7 and a slide operation lever 18 for operating the slide device 8 are provided. The reclining operation lever 17 corresponds to a seat back angle adjustment operation unit of the present invention, and the slide operation lever 18 corresponds to a seat front-to-rear position adjustment operation unit of the present invention.

The reclining operation lever 17 and the slide operation lever 18 that are the seat adjustment operation units 14 are disposed to avoid the vicinities of the grip portions 11. Since the seat adjustment operation units 14 are disposed to avoid the grip portions 11, when the occupant H instantaneously stretches out the hand to the grip portion 11, a situation in which the hand hits the seat adjustment operation unit 14, thereby resulting in the erroneous operation of the reclining device 7 or the slide device 8, can be suppressed.

### Specifically, As Shown in FIG. 4, the Reclining

operation lever 17 is provided at a side portion of the headrest 3 formed integrally with the seat back 2. In addition, when the headrest 3 and the seat back 2 re created separately, the reclining operation lever 17 may be provided at an upper end portion of the seat back 2.

Since the reclining operation lever 17 is provided separated from the grip portions 11 provided at a front end portion of the seat cushion 1, even if the occupant H instantaneously stretches out the hand to the grip portion 11 when the vehicle V shakes violently, the hand does not touch the reclining operation lever 17. Therefore, erroneous operation of the reclining device 7 is suppressed.

In addition, the slide operation lever 18 is provided to release the locking of the slide device 8 and to allow the slide device 8 to move when the front-to-rear position of the conveyance seat S is changed. As shown in FIG. 1, the slide operation lever 18 is disposed below the front end portion of the seat cushion 1. Since the slide operation lever 18 is disposed below the front end portion of the seat cushion 1, even when the hand is stretched out to the grip portion 11, the arm or hand does not erroneously come into contact with the slide operation lever 18, and erroneous operation of the slide device 8 is suppressed.

### Changing Position of Grip Portion 11

The grip base 10 may be provided with a grip position change unit 19, and the grip position change unit 19 may be configured to be able to change the position or the inclination angle a of the grip portion 11 in the extending direction. It is preferable that changing the position of the grip portion 11 can be realized by moving the grip portion 11 itself in the up to down direction or, as shown by a dotted line in FIG. 2, rotating the grip portion 11 around an axis extending in the seat front to rear direction. In addition, regarding changing the inclination angle a of the grip portion 11, it is preferable that the grip portion 11 is provided on the grip base 10 such that the grip portion 11 is rotatable in the front to rear direction around an axis extending in the seat width direction. Since the configuration in which the position or the inclination angle a of the grip portion 11 in the extending direction is changeable is employed, the grip portion 11 can be disposed at an appropriate position adapted to the physique of the occupant H.

An actuator may be provided in the grip position change unit 19, and may electrically operate the grip portion 11 such that the position or the inclination angle a thereof can be automatically changed. In this case, the grip position change unit 19 that moves the grip portion 11 is connected to and controlled by an ECU 20 provided inside the vehicle or in the conveyance seat S. The ECU 20 corresponds to a control unit of the present invention.

When the occupant H is not seated in the conveyance seat S, the grip portions 11 may be rotated and moved to be located below a seating surface of the seat cushion 1. By lowering the position of the grip portions 11, the occupant H is allowed to easily get in the conveyance seat S.

In this case, when the locking of a buckle 16 of the seat belt 15 is detected by a lock sensor 21 provided in the buckle 16, it is preferable that the ECU 20 causes the grip portions 11 to be raised and causes the grip portions 11 to be disposed at a position where the occupant H naturally grasps the grip portions 11. In this case, the ECU 20 may estimate the body weight or physique of the occupant H using a seating sensor, and may cause the grip portions 11 to be disposed at an appropriate position.

### Modification Example

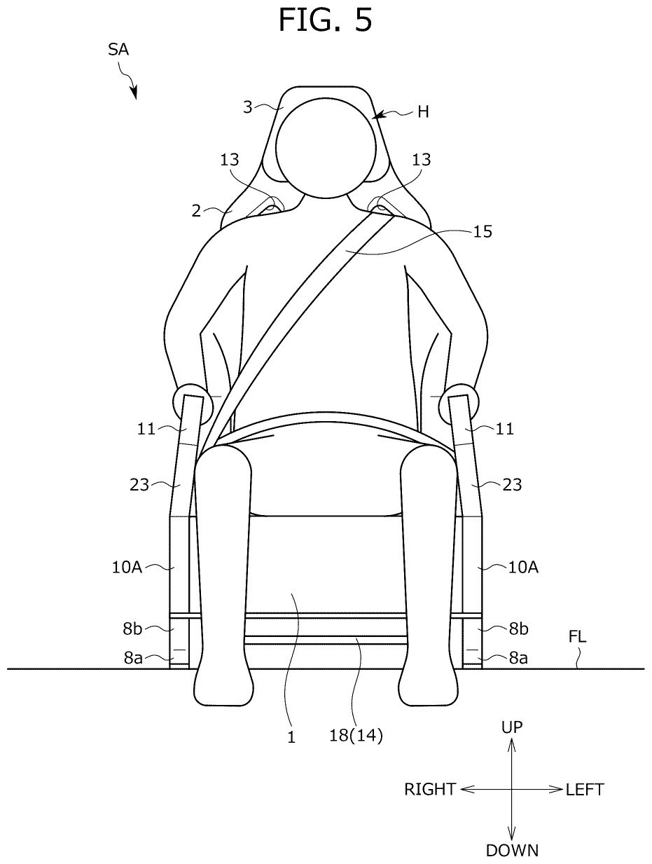

In the conveyance seat S shown in FIGS. 1 to 4, the recesses 12 are provided in the grip bases 10 and support the thighs; however, means for supporting the thighs is not limited thereto. For example, as in a grip base 10A of a conveyance seat SA shown in FIG. 5, the grip base 10A may include an inclined portion 23 instead of the recess 12. The inclined portion 23 is inclined to be located outward in the seat width direction as the inclined portion 23 extends from an upper end portion toward a lower end portion of the inclined portion 23. In other words, the inclined portion 23 is formed such that the upper end portion that supports the grip portion 11 is located inside the lower end portion in the seat width direction. The occupant H can support the lower body by pressing the thighs against the inclined portion 23 that is inclined inward.

### Second Embodiment

In the conveyance seat S shown in FIGS. 1 to 4, the grip portion 11 is provided at the front of the side portion of the seat cushion 1, which is located at a position where the occupant naturally stretches out the hand; however, the position where the grip portion 11 is provided is not limited thereto.

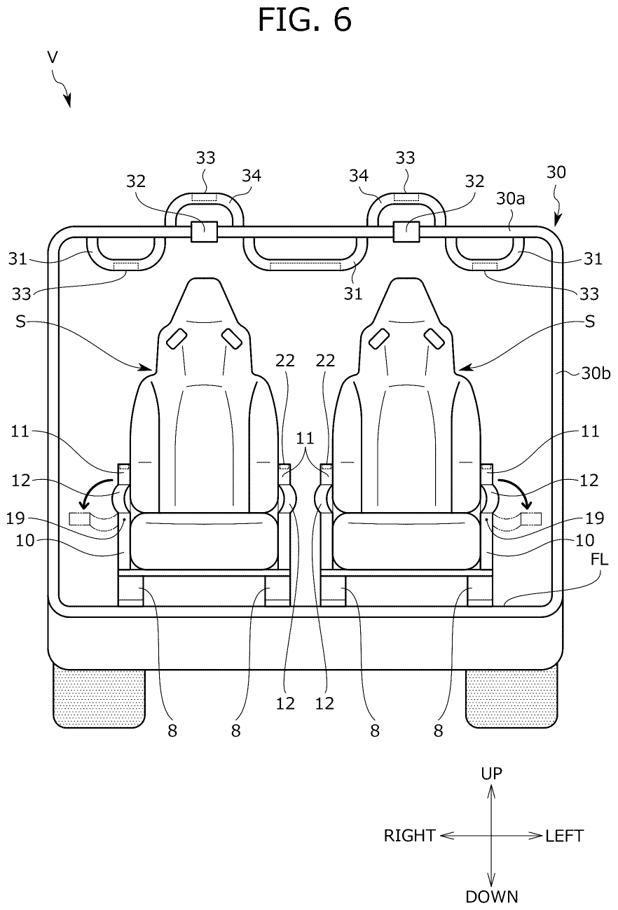

For example, when the conveyance is the four-wheeled off-road vehicle V, as shown in FIG. 6, a roll bar grip portion 31 may be provided below an upper portion 30a of a roll bar 30. A lower portion of the upper portion 30a of the roll bar 30 is located at a position that the occupant H reaches by naturally stretching out the hand, and by providing the roll bar grip portion 31 at that portion, the occupant H is allowed to instantaneously grasp the roll bar grip portion 31. Since the roll bar grip portion 31 is provided below the upper portion 30a, the direct gripping of the roll bar 30 by the occupant H is suppressed. Namely, by providing the roll bar grip portion 31 below the upper portion 30a, physical stability when the vehicle V shakes can be enhanced.

Similarly to the grip portion 11 provided in the conveyance seat S, the roll bar grip portion 31 may be provided with a lighting device 33. When the vehicle V travels at night, the periphery of the roll bar grip portion 31 becomes bright, so that the occupant H can reliably grip the roll bar grip portion 31.

In addition, a protection member 34 may be disposed around a member in contact with the roll bar 30, for example, around a roll bar support portion 32. In addition, similarly to the roll bar grip portion 31, the protection member 34 may be provided with the lighting device 33.

The embodiments of the present invention have been described above with reference to the drawings. In the present embodiment, the conveyance seat that is installed in a four-wheeled off-road vehicle has been described; however, the conveyance seat may be installed not only in off-road vehicles that travel on rough terrain, but also in on-road vehicles that travel on paved roads.

### REFERENCE SIGNS LIST

V: vehicle
S: conveyance seat
P: pad
T: skin
1: seat cushion
2: seat back
3: headrest
7: reclining device
8: slide device
   8a: lower rail
   8b: upper rail
10, 10A: grip base (side support portion)
11: grip portion
12: recess
13: belt passage hole
14: seat adjustment operation unit
15: seat belt
16: buckle
17: reclining operation lever (seat back angle adjustment operation unit)
18: slide operation lever (seat front-to-rear position adjustment operation unit)
19: grip position change unit
20: ECU (control unit)
21: lock sensor
22: lighting device
23: inclined portion
30: roll bar
   30a: upper portion
31: roll bar grip portion
32: roll bar support portion
33: lighting device
34: protection member

1. A conveyance seat, comprising:
a seat cushion; and
a side support portion that is provided on a side portion of the seat cushion, and that supports thighs of an occupant, who is seated in the conveyance seat, from an outside in a seat width direction.

2. The conveyance seat according to claim 1,
wherein the side support portion includes a recess recessed from an inside toward the outside in the seat width direction.

3. The conveyance seat according to claim 1,
wherein the side support portion includes an inclined portion in which an upper end portion is located inside a lower end portion in the seat width direction.

4. The conveyance seat according to claim 1, further comprising:
a grip portion located at a front of a side portion of the conveyance seat.

5. The conveyance seat according to claim 4,
wherein the grip portion is supported by the side support portion.

6. The conveyance seat according to claim 4,
wherein an extending direction of the grip portion is inclined downward from a front toward a rear.

7. The conveyance seat according to claim 4,
wherein the grip portion is provided on each of the right and left side portions of the seat cushion.

8. The conveyance seat according to claim 1, further comprising:
a slide device that is provided below the seat cushion and that slidably attaches the conveyance seat to a floor surface,
wherein the slide device includes a lower rail fixed to the floor surface, and an upper rail that slides on the lower rail, and
the side support portion is fixed to the upper rail.

9. The conveyance seat according to claim 4,
wherein the grip portion is attached such that a position or an inclination angle of the grip portion in an extending direction is changeable.

10. The conveyance seat according to claim 9, further comprising:
a grip position change unit that changes the position or the inclination angle of the grip portion in the extending direction;
a seat belt including a buckle;
a lock sensor that detects a locking of the buckle; and
a control unit that is connected to the lock sensor, and that controls the grip position change unit,
wherein when the lock sensor detects the locking of the buckle, the control unit drives the grip position change unit to change the position or the inclination angle of the grip portion.

11. The conveyance seat according to claim 4, further comprising:
a seat adjustment operation unit that receives an input for changing a position or a shape of the conveyance seat,
wherein the seat adjustment operation unit is disposed to avoid the vicinity of the grip portion.

12. The conveyance seat according to claim 11, further comprising:
a slide device that is provided below the seat cushion and that slidably attaches the conveyance seat to a floor surface,
wherein the seat adjustment operation unit is a seat front-to-rear position adjustment operation unit that receives an input for adjusting a front-to-rear position of the conveyance seat using the slide device, and
the seat front-to-rear position adjustment operation unit is disposed below a front end portion of the seat cushion.

13. The conveyance seat according to claim 11, further comprising:
a seat back;
a headrest; and
a reclining device that rotates the seat back in a front to rear direction with respect to the seat cushion,
wherein the seat adjustment operation unit is a seat back angle adjustment operation unit that receives an input for adjusting an inclination angle of the seat back with respect to the seat cushion using the reclining device, and
the seat back angle adjustment operation unit is disposed at an upper end portion of the seat back or a side portion of the headrest.

14. A method for manufacturing a conveyance seat, comprising:
preparing a seat cushion and a side support portion that supports thighs of an occupant, who is seated in the conveyance seat, from an outside in a seat width direction; and
attaching the side support portion to a side portion of the seat cushion.

15. The method for manufacturing the conveyance seat according to claim 14, comprising:
preparing a grip; and
attaching the grip to a front of a side portion of the conveyance seat.

16. The method for manufacturing the conveyance seat according to claim 15, wherein
the grip portion is attached such that a position or an inclination angle of the grip portion in an extending direction is changeable.

17. The method for manufacturing the conveyance seat according to claim 16, comprising:
preparing a grip position change unit that changes the position or the inclination angle of the grip portion in the extending direction, a seat belt including a buckle, a lock sensor that detects a locking of the buckle and a control unit that is connected to the lock sensor and that controls the grip position change unit; and
attaching the grip position change unit, the seat belt, the lock sensor and the control unit to the conveyance seat,
wherein when the lock sensor detects the locking of the buckle, the control unit drives the grip position change unit to change the position or the inclination angle of the grip portion.
